(19) United States
(12) Patent Application Publication
(10) Pub. No.: US 2019/0298074 A1
(43) Pub. Date: Oct. 3, 2019

(54) MATTRESS WITH AN INTEGRATED MATTRESS ADJUSTMENT APPARATUS

(71) Applicant: COMFORT SYSTEMS (2007) LTD, Kfar Saba (IL)

(72) Inventor: Jehoshua DAN-ON, Ra'anana (IL)

(73) Assignee: COMFORT SYSTEMS (2007) LTD.

(21) Appl. No.: 16/364,263

(22) Filed: Mar. 26, 2019

Related U.S. Application Data
(63) Continuation-in-part of application No. 16/221,713, filed on Dec. 17, 2018.

(30) Foreign Application Priority Data
Mar. 27, 2018 (IL) 258387

(51) Int. Cl. A47C 20/04; A61G 7/015; A61G 7/018

(52) U.S. Cl. CPC A47C 20/041; A47C 27/04; A61G 7/018; A61G 7/015

(57) ABSTRACT

An adjustable mattress frame suitable to be fully contained within a mattress is provided with a central body segment and with upper and lower body adjustable segments pivotally connected by one or more hinges to said central body segment, said central body segment being provided with one or more actuation modules suitable to actuate said upper and lower body segments respectively.

### FIELD OF THE INVENTION

The present invention relates to the field of comfort systems. More particularly, the invention relates to an adjustable mattress in which the mechanism achieving the adjustment is fully contained therein without external parts.

### BACKGROUND OF THE INVENTION

Various forms of beds and mattresses have been used for centuries as a padded surface for supporting a reclining body. It is well known in the field of medicine and hospital beds that a static fully reclined bed and mattress may cause severe health issues, such as infections. The first adjustable bed was introduced in the early 1900's by Dr. Willis Dew Gatch, and to this day Dr. Gatch's basic idea of separating a bed into three segments and tilting each segment separately is practiced in hospitals and medical facilities worldwide.

As it has been realized that besides the health advantages, adjustable beds offer recreational and entertainment solutions, such as reading, watching television and using a laptop computer in bed, adjustable beds have become a common piece of furniture available in household bedrooms.

In many cases after falling asleep in an adjustable bed, there is need in changing the position of the bed. The preferred position for sleeping is usually different from various positions that a bed may be positioned beforehand. Obviously manual changing of the bed's position is impossible after falling asleep. Moreover, additional room parameters, such as lighting, music volume, air-conditioning, TV, etc., as they were set during waking time, may also not be appropriate during sleep. Adjusting such parameters for a sleeping individual would also be highly desirable.

It is an object of the present invention to provide a comfort system that is free from the disadvantages of existing products and which is adjustable by means of a mechanism that is fully contained within the boundaries of the mattress (referred to herein also as “mattress mechanism” or simply as “mechanism”). The term “comfort system”, as used herein is meant to encompass adjustable systems suitable for different uses, such as simple sleeping, active resting (such as when reading, watching TV, using a laptop, etc.), as well as for health purposes, such as used in hospitals or at home with infirm or elderly people.

It is therefore another object of the present disclosure to provide an adjustable comfort system capable of automatically obtaining a preferred sleeping position. It is a further object of the invention to provide a comfort system that is adapted to control additional environmental parameters.

Other objects and advantages of the invention will become apparent as the description proceeds.

### SUMMARY OF THE INVENTION

The present invention relates to an adjustable mattress frame suitable to be fully contained within a mattress, provided with a central body segment and with upper and lower body adjustable segments pivotally connected by one or more hinges to said central body segment, said central body segment being provided with two or more actuation modules suitable to actuate said upper and lower body segments respectively, and to a mattress containing it.

According to an embodiment of the invention, the frame comprises two adjustable segments on opposite sides of the base segment. In some embodiments of the invention, at least one adjustable segment comprises two sections, a first section abutting the base segment and the other section abutting the first section, and wherein sections are adjusted simultaneously.

According to one embodiment of the invention, the first section is actuated in the same manner an adjustable segment if actuated, and the second section comprises a top side pivotally connected by one or more hinges to the first section and a bottom side pivotally connected by arms to the base segment. According to another embodiment of the present invention, the frame further comprises a force absorbing apparatus suitable to absorb forces applied to the second section. In some embodiments of the invention, the frame comprises an upper body segment; a lower body segment; and a central body base segment.

The actuation apparatus typically (but not limitatively) comprises an electric motor, a linear actuator, and a motion-transmission module configured to transmit rotation of the motor to linear motion of the linear actuator. In some cases the at least one adjustable segment is connected to the linear actuator and is actuated thereby. According to another embodiment of the invention, the linear actuator is adapted to produce a linear motion that is transferred to the adjustable segment as a linear motion by levers that are pivotally fixed on one side to the adjustable segment and on the other side to the base segment.

The mattress may further comprise a power source suitable to provide power to the motor. Said power source can for instance be selected from an electrical cable configured to be connected to a power outlet, a battery cell, a rechargeable battery cell and a charge port, a power port configured to receive power from a remote battery cell, or a combination of two or more of said sources. According to some embodiments of the invention, the matters comprises a maintenance opening.

According to a further embodiment of the invention, the mechanism (also referred to as “frame”) has a thickness of 8 cm or less, and in some embodiments the mattress does not exceed the height of a standard mattress. According to still another embodiment of the present invention, the boundary material is that of a flexible mattress casing. The padding material can connected, in one instance, on a cover located on the top side of the adjustable frame and separating said frame from said padding material. The padding material can be of any suitable material and, for instance, it may comprise springs, foam, memory foam, gel, latex, or any combination thereof.

In another aspect, the present invention relates to an adjustable twin, king size or queen-size and all sizes of existing mattress system comprising two adjustable frames arranged parallel and adjacent to each other, or integrally formed with one another to create a single double frame, padding material located above each adjustable frame, and flexible mattress-casing means enveloping said adjustable frames. In some embodiments of the present invention the mattress casing means consists of two separate casings comprising a fastening apparatus configured to bind them into a uniform structure and to allow separation thereof.

In a further aspect the invention relates to an adjustable twin, King size or queen-size and all sizes of existing mattress system comprising:
a) one double-sized adjustable frame;
b) padding material located above said adjustable frame; and
flexible mattress-casing means enveloping said adjustable frame.

In another aspect the invention relates to an adjustable mattress, wherein the actuation module is adapted to be operated automatically upon determination of a waking/sleeping state of a user.

In one embodiment the adjustable mattress is configured to be automatically brought to a previously defined position of the at least one adjustable segment.

Accordingly, there is also provided an adjustable mattress comprising:
i. one or more sensors configured to measure one or more parameters related to the sleep state of an individual; and
ii. a control circuitry to which measurements from the sensors are sent, configured to analyze the measurements and control the at least one adjustable segment for bringing it to the predefined position.

The one or more parameters are typically (but not limitatively) chosen from a list comprising: the weight exerted on the mattress at various locations, sounds produced around the mattress and motion across the mattress. In one embodiment the adjustable mattress is further configured to automatically bring the environmental parameters of room environment systems to a previously defined state.

In another embodiment the control circuitry of the adjustable mattress comprises a machine learning module for autonomously learning habits and preferences, and accordingly defining mattress positions, and for autonomously obtaining the defined mattress positions.

Also encompassed by the invention is an adjustable mattress system comprising an adjustable mattress and a software application with which the previously defined position is defined.

### BRIEF DESCRIPTION OF THE DRAWINGS

In the drawings:

FIG. 1A shows a perspective view of an adjustable mattress, according to an embodiment of the present invention, in which the lower part of the mattress boundaries has been removed to expose the adjustment mechanism and the upper part of said boundaries is shown in transparency;

FIG. 1B shows the mattress of FIG. 1A in operational form, illustrating the absence of any external mechanism;

FIG. 1C illustrates how the mattress of FIG. 1B can be simply positioned on a surface, such as a regular bed frame;

FIG. 2 shows a top view of an adjustable single mattress frame according to an embodiment of the present invention;

FIG. 3 shows a bottom view of the central body segment of the frame of FIG. 2, according to an embodiment of the present invention;

FIG. 4A schematically illustrates the upper body segment of the frame of FIG. 2 in a fully reclined position, according to an embodiment of the present invention;

FIG. 4B shows the upper body segment of FIG. 2 in a partial upright position;

FIG. 5A schematically illustrates the lower body segment of the frame of FIG. 2 in a fully reclined position, according to an embodiment of the present invention;

FIG. 58 shows the lower body segment of the frame of FIG. 2 in a not-fully reclined position, according to an embodiment of the present invention;

FIG. 6A illustrates the segmented upper structure of the inner portion of a double-size mattress (as may be, for instance, a King-size or a Queen-size mattress), showing the cover of the mechanism as well as the frame that contains it;

FIG. 6B shows the structure of FIG. 6A, sized for a Queen-size mattress, the dimensions been shown;

FIG. 6C is a side view of the structure of FIG. 6B, showing the frame and its thickness (in this case, 80 mm);

FIG. 7A shows an assembled frame 601 of FIG. 6B with its cover removed;

FIG. 7B shows the same frame of FIG. 6A, with its elements separated;

FIG. 8 is an exploded view of frame 602 of FIG. 6A;

FIG. 9 is a bottom perspective view of a mechanism adapted to operate a Queen-size mattress;

FIG. 10 is a perspective bottom view of the base and upper body lifting sections of the mattress mechanism of FIG. 9;

FIG. 11 is a perspective bottom view of the base and legs sections of the mattress mechanism of FIG. 9;

FIG. 12 is a gas spring adapted to operate the leg section of FIG. 11;

FIG. 13 is a schematic illustration of the functioning of a double mattress according to an embodiment of the invention, with remote control; and

FIG. 14 is a schematic illustration of the functioning of two, coupled mattresses, according to another embodiment of the invention, with remote control.

### DETAILED DESCRIPTION OF THE INVENTION

Reference will now be made to embodiments of the present invention, examples of which are provided in the accompanying figures for purposes of illustration only. One skilled in the art will readily recognize from the following description that alternative embodiments of the structures and methods exemplified herein may be employed, mutatis mutandis, without departing from the principles of the invention.

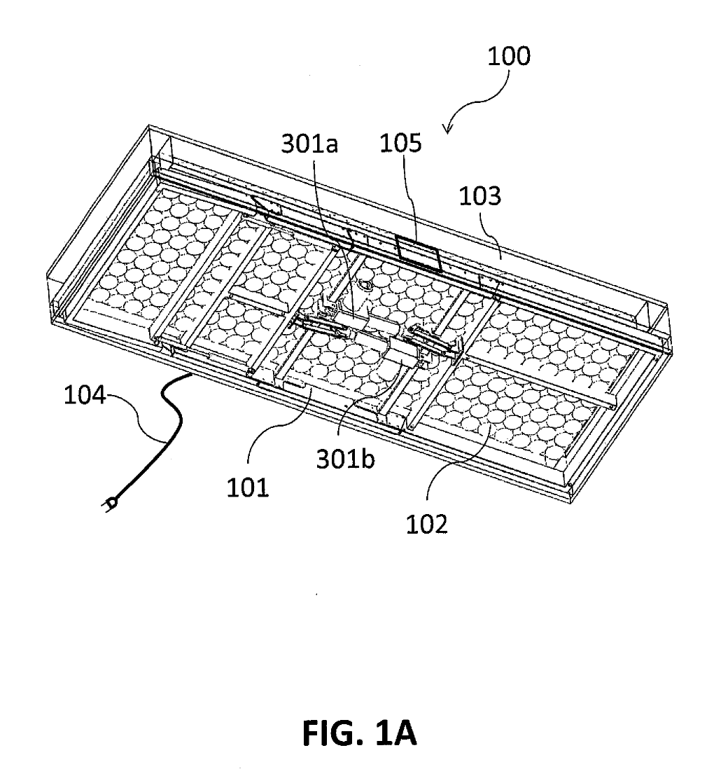

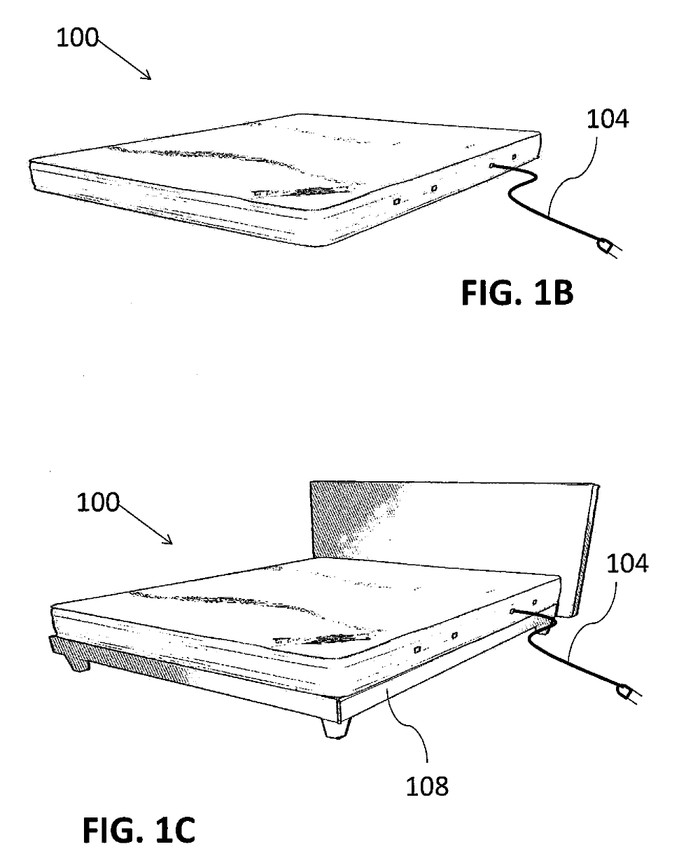

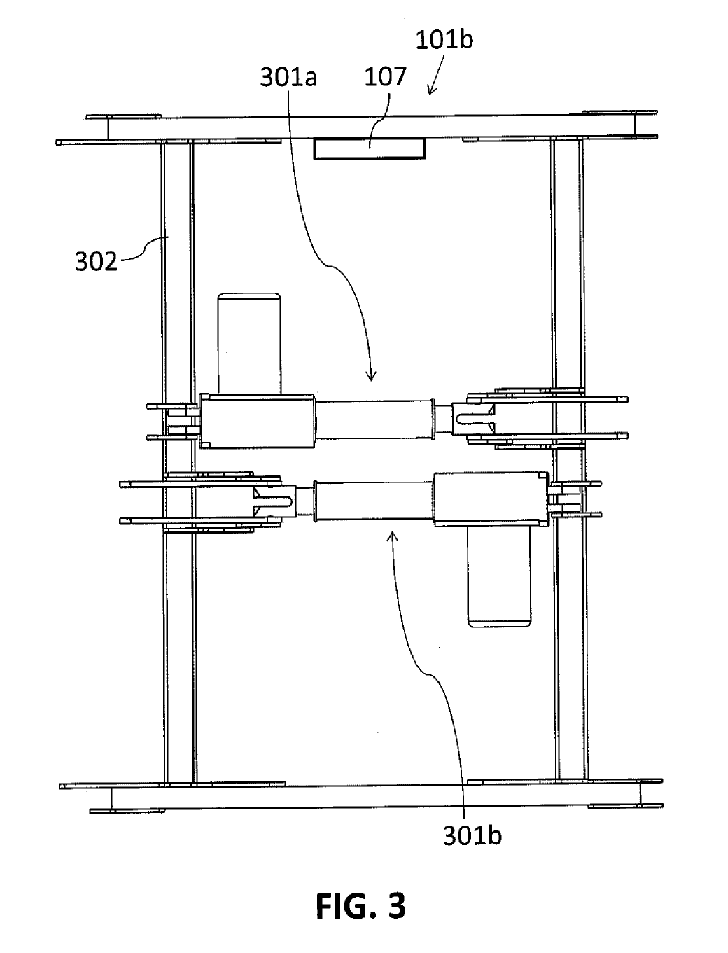

FIG. 1A shows a perspective view from the bottom side of an adjustable mattress 100, according to an embodiment of the present invention, comprising an adjustable frame 101, a padding apparatus 102 (e.g. springs, foam, memory foam, gel, latex, etc.), and a flexible mattress-casing 103 (shown transparent in FIG. 1 with the bottom portion removed). Padding apparatus 102 is situated on rigid planks that are connected to the top side of adjustable frame 101 such the top side of padding apparatus 102 imitates the position of frame 101. Consequently, by adjusting frame 101 the position of the whole mattress 100 is adjusted. In one embodiment a cable 104, which is connectable to a source of electric power, aliments a control device (not shown) that, inter alia, operates motors 301a and 301b further discussed with reference to FIG. 3.

As will be immediately appreciated by the skilled person, the mattress of the invention is unique in that its mechanism is completely contained within the mattress and encased thereby, with no parts of the mechanism being located outside the contours of the mattress. This is distinct from previous attempts made to provide adjustable surfaces, such as that described in EP 2374376, which is needed to function to possess balancing bars that extend from the adjustment mechanism to the bedding, so as to make the mattress portion a part of the bedding which cannot be easily moved to a desired location, or that of U.S. Pat. No. 7,690,060, which similarly requires an external stabilization structure, both which teach away from the invention. Moreover, the dimensions of the bed described in the aforementioned EP application are not those of a regular mattress, since the dimensions it achieves are 8 inches (20.32 cm), while, as will be further described below, the invention allows to provide a mechanism that is much thinner and the thickness of which will typically not exceed 8 cm. The aforementioned drawbacks of the prior art, in contrast, are those that made it impractical and caused it to fail.

FIG. 1B is a schematic perspective external view of a mattress comprising the mechanism of FIG. 1A. As can be seen, no moving or mechanical parts are seen outside the mattress casing and, with the exception of cable 104, the mattress appears like any regular, non-adjustable mattress.

FIG. 1C illustrates the use of mattress 100 on a bedding frame, but of course the mattress of the invention is completely movable and can be used on any surface without the need for any special preparation thereof.

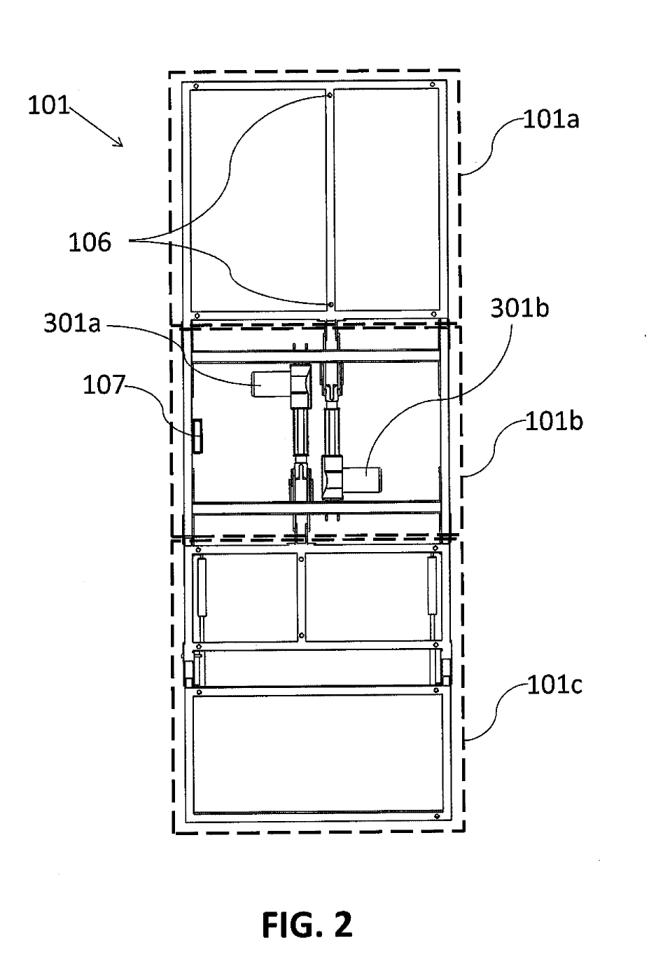

FIG. 2 shows a top view of adjustable frame 101, according to an embodiment of the present invention, comprising three segments: upper body segment 101a, central body segment 101b, and lower body segment 101c, each made of metal profiles.

As said, the adjustable mattress frame of the invention has the considerable advantage of being thin, thus permitting its full incorporation in a mattress of regular size and thickness. The typical total height of frame 101 can be, for instance, 5-7.5 cm or even less if desired. Several different motors can be selected for actuating the frame, and those can be provided with different sizes.

Persons skilled in the art will easily provide actuating motors that are capable of delivering the required power. An illustrative and non-limitative example of a motor that is suitable for operating a frame according to the invention is an OD-11 electric motor available from ODIN® (www.odin-manufacture.com, China), which generates a maximal thrusting force of 6000N for the linear actuator to extend 50 mm, with a low noise operation in a 77 mm high package. In one exemplary embodiment the following specification can be used for a motor:
Actuator Motor DC24V
Stroke 38, 50, 100, 150, 200 mm
Max Actuator Speed—6 mm/s
Max Force Push—3000, 3500, 6000, 8000N
Max Force Pull—3000N
Max Critical Dimension is 80 mm—outer dimension of the Motor
Duty Cycle—10%

Table 1 shows examples of suitable configurations:

TABLE 1

| | | | | Dimensions in | |
|---|---|---|---|---|---|
| | | | | Close Position | Max |
| | Stroke, | Force | Force | (Retracted | Noise, |
| Motors | mm | Push, N | Pull, N | Length), mm | dBA |
| 1 | 0-60 | 6000-8000 | — | 216 | 50 |
| 2 | 0-60 | 6000-8000 | — | 216 | 50 |
| 3 | 0-60 | 6000-8000 | — | 216 | 50 |
| 4 | 0-60 | 6000-8000 | — | 216 | 50 |
| 5 | 0-200 | 3500-6000 | 3500 | 306 | 50 |
| 6 | 0-200 | 3500-6000 | 3500 | 306 | 50 |
| 7 | 0-200 | 6000-8000 | 4000 | 356 | 50 |
| 8 | 0-200 | 6000-8000 | 4000 | 356 | 50 |

A controller adapted for two users (double mattress or two coupled single mattresses) may for instance have the following specifications:
The Controller may connect to up to 8 Motors—up to 4 Synchronized motor pairs
2 Remote Control Units BLE
Remote Control from Application iOS/Android
8 Digital Inputs
Serial connection between 2 controllers. Master and slave controllers, the first is the one that receives a command and becomes a master until the command is finished. No other Action takes place at the same time.
2×USB connectors for Power Supply only
Optional Wi-Fi port for internal Control
Optional External Power Bank for release system only (for example—a 9V battery or similar)
Push Button for pairing with Remote Control and Smart phone for Controller
Exemplary Dimensions: 30 mm×180 mm×300 mm.

A system that utilizes such controller is schematically illustrated in FIGS. 13 and 14. In FIG. 13 numeral 130 indicates a double bed, and in FIGS. 14 140a and 14b illustrate two single beds that are operated separately. Referring to FIG. 13, numeral 131 is a controller that can be operated by either smart phone 132 or 133, or by remote control 134 or 135. As said the first of the controlling device (either a smartphone or a remote control) that sends a command signal to controller 132 is the master device until that operation is completed.

In contrast, the configuration of FIG. 14 has two mattresses, 140a and 14b that are operate by two separate controllers, 141a and 141b. In one embodiment, each individual mattress can be operated separately. Conversely, in the embodiment shown in FIG. 14 both smartphones 142 and 14, and both remote controls 144 and 145, can operate either mattress. Of course, there is no absolute need to have both a smartphone and a remote control and in some embodiments only one of them will be used, although if desired both can be made operative.

The following illustrative specifications apply to an exemplary remote control:
Bluetooth connection to controller
Possibility to connect 2 Remote Controls to one Controller
Each Remote Control can control 2 different mattresses

The term “smartphone” as used herein should be understood to encompass any smart device, such as tablets, PCs, etc. The Application running on the smartphone, be it using iOS or Android, should support all the functions of a remote control and should preferably allow for voice control via conventional tools such as Google, Siri, Amazon Echo, Alexa, etc. Moreover, control of the system can be allowed, if desired, via Wi-Fi, cloud services, and the like external systems.

The frame and the elements that actuate it can be made of any suitable material that can withstand the mechanical forces applied thereto. Depending on the weight requirements for the final product, material such as industrial steel or other metal can be used, as well as light composite materials. Of course, the type of materials employed for the frame and its actuation will also affect the thickness of the assembly, as well as its weight and cost, and the skilled person will easily select the appropriate materials for an intended use.

It is noted that the present invention is not limited to a three-segment frame, and may be performed with any other number of segments, e.g. four segments.

FIG. 3 shows a bottom view of central body segment 101b of FIG. 2, according to an exemplary embodiment of the present invention, comprising an upper body actuation module or apparatus 301a and a lower body actuation module or apparatus 301b, both connected to substructure 302 which supports central body segment, 101b. Each actuation module 301a and 301b comprises a motor and a set of actuators and levers suitable to be actuated by the motor and to cause the upper and lower body segments to be adjusted, respectively, as explained in detail hereinbelow.

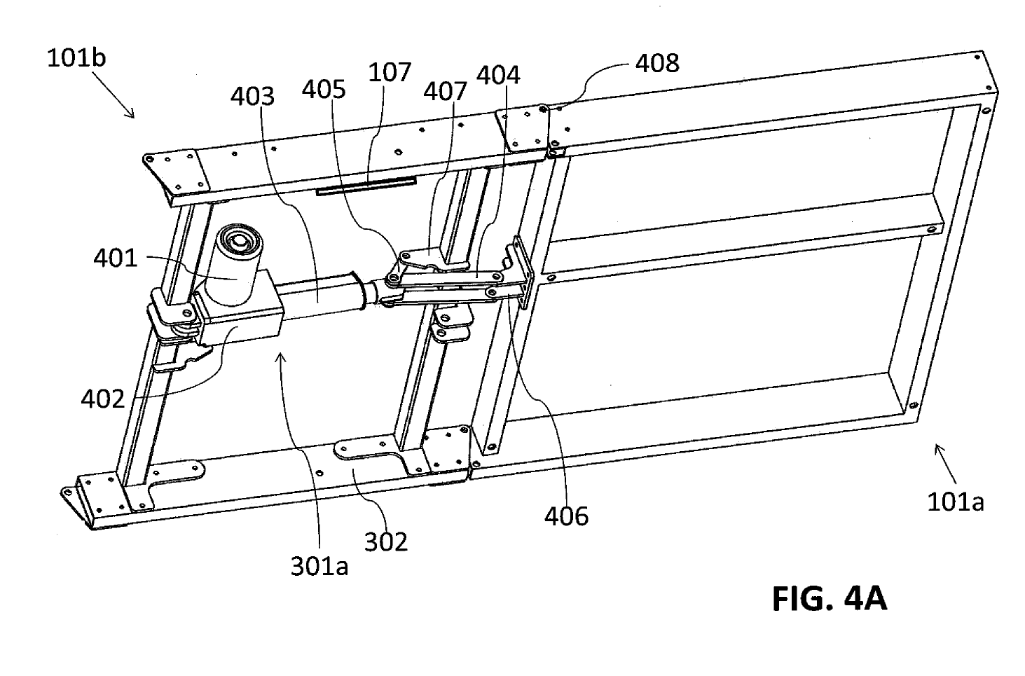

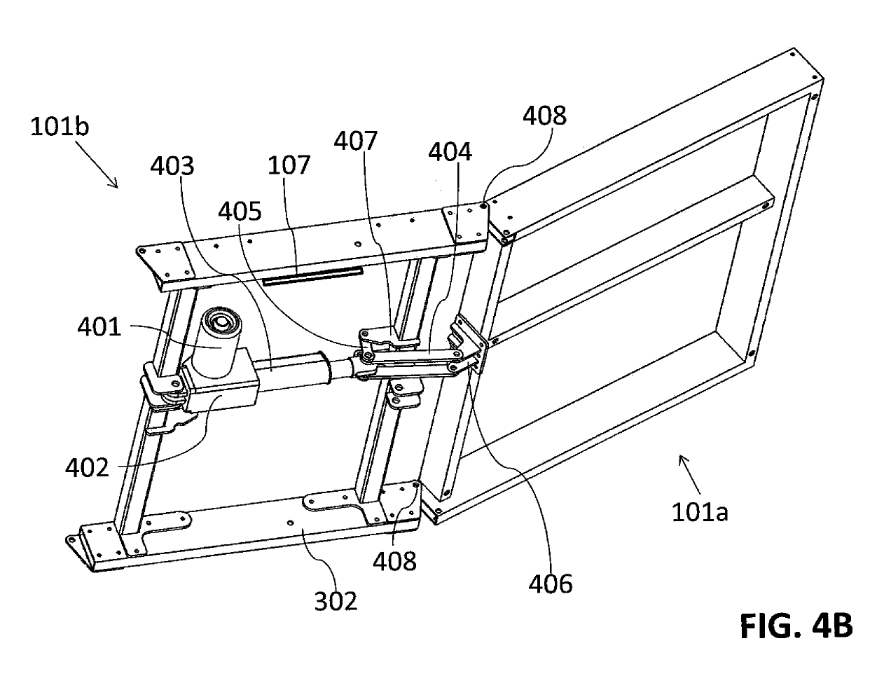

FIG. 4A schematically illustrates upper body segment 101a in a fully reclined position, along with upper body actuation module 301a, according to an embodiment of the present invention. Actuation module 301a comprises an electric motor 401, a motion-transmission module 402 and a linear actuator 403. Rotation of motor 401 is transmitted to linear motion of actuator 403 by transmission module 402, i.e. rotation in one direction of motor 401 causes linear actuator 403 to extend distally from transmission module 402, and rotation in the other direction causes linear actuator 403 to retract proximally into transmission module 402. The linear motion of actuator 403 is transferred to upper body segment 101b via levers 404 that are pivotally fixed to the upper body segment by anchoring members 406. According to an embodiment of the present invention, levers 404 are connected to substructure 302 via rotational levers 405 (that are pivotally fixed to anchoring members 407). Levers 405 are provided so as to maintain the motion of levers 404 above a predefined level which is determined by the length of levers 405. Upper body segment 101a is axially connected to substructure 302 at hinges 408. Linear distal actuation of actuation module 301a causes upper body segment 101b to be separated from central body segment 101b, however hinges 408 prevent complete separation of segments 101a and 101b. Consequently linear actuation of actuation module 301a causes segment 101b to rotate around hinges 408, as shown in FIG. 4B where upper body segment 101a is brought to a partially upright position by the operation of actuation module 301a.

When upper body segment 101a is tilted (i.e. not fully reclined) it is supported solely by center body segment 101b. Accordingly, motor 401 is required to resist the horizontal component of the torque collapsing force applied by upper body segment 101a being leaned upon. According to an embodiment of the present invention, motor 401 is capable of withstanding a load of up to 6000 Newton which is fairly enough relative to the weight applied by an average weighted person leaning on upper body segment 101a. Furthermore, the vertical component of force applied to the upper body segment is transferred to substructure 302, which is statically situated as the base of frame 101.

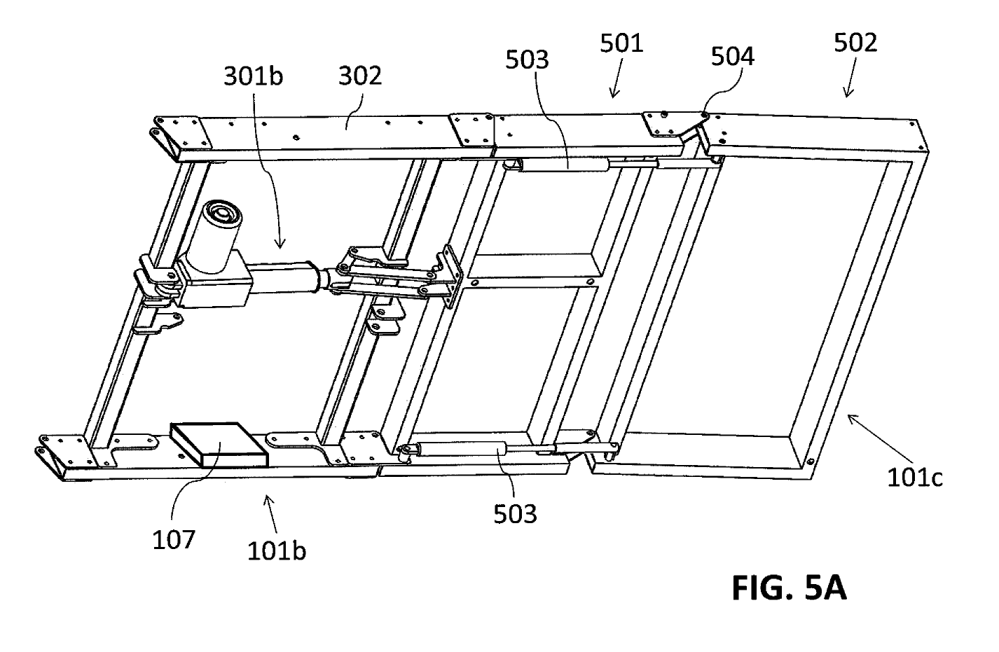

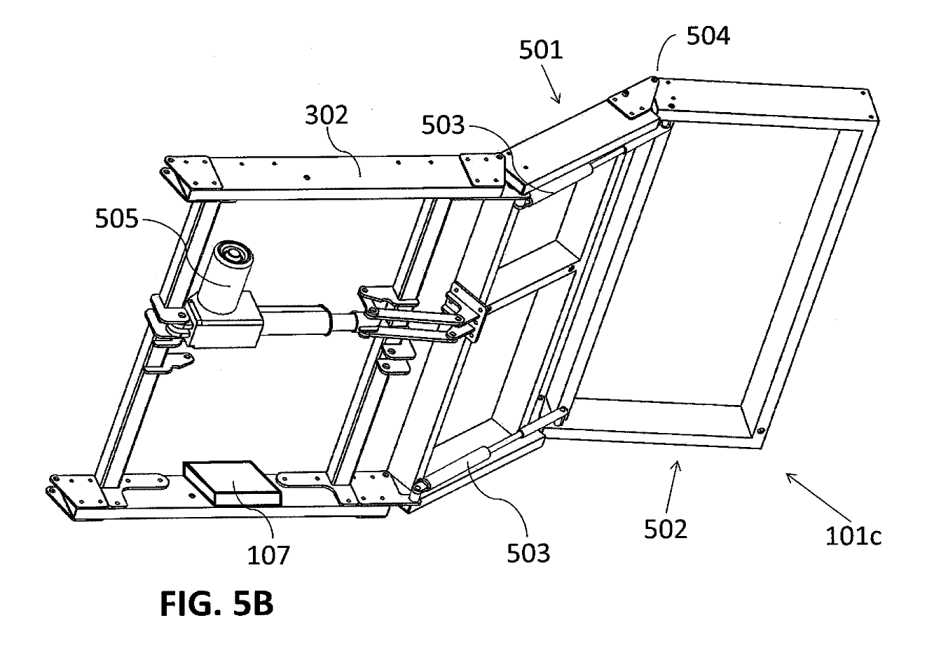

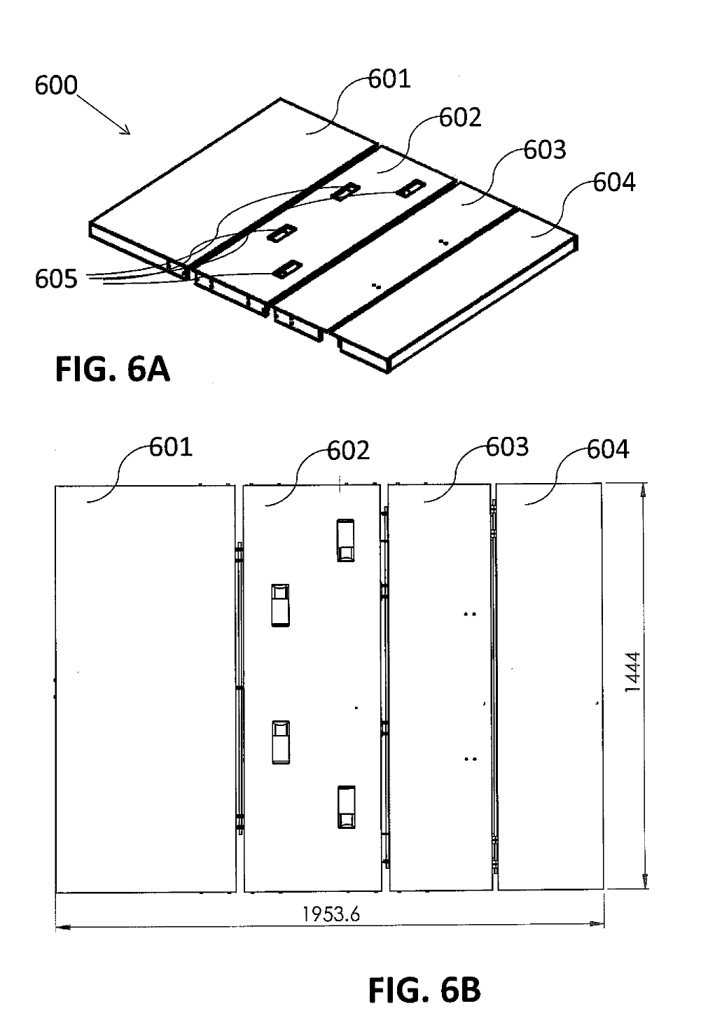

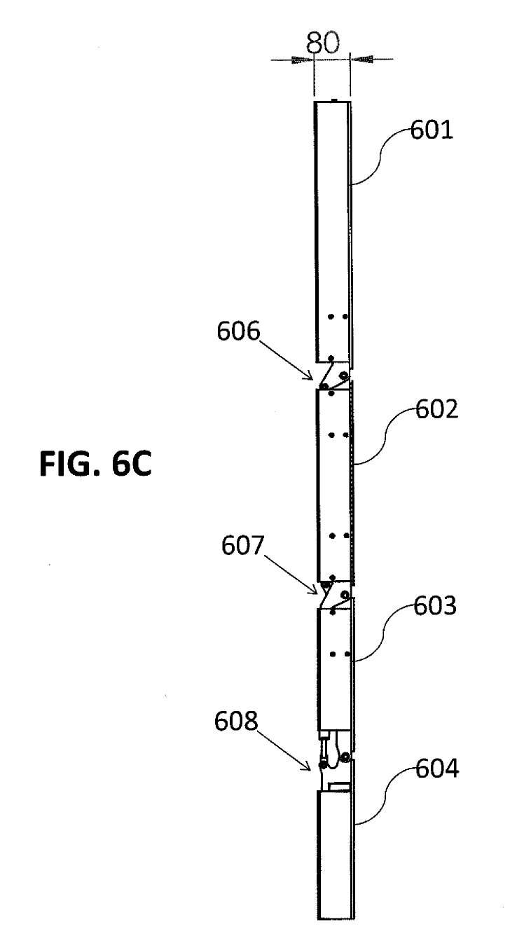

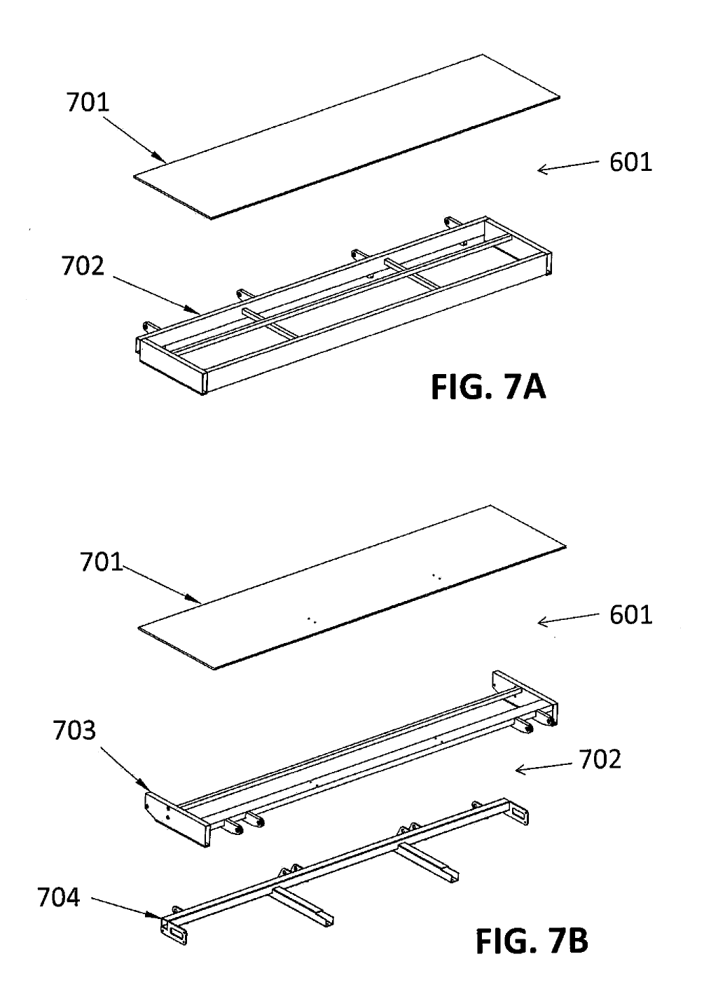

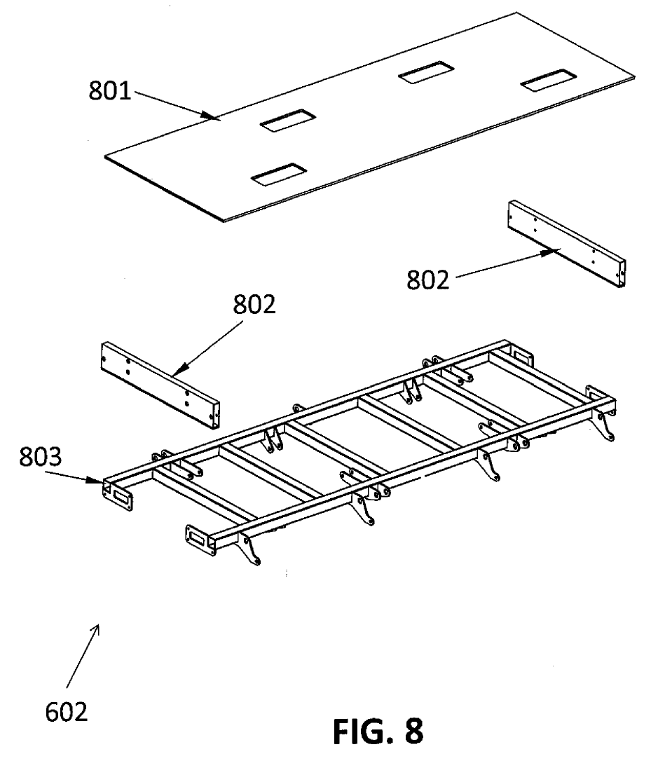

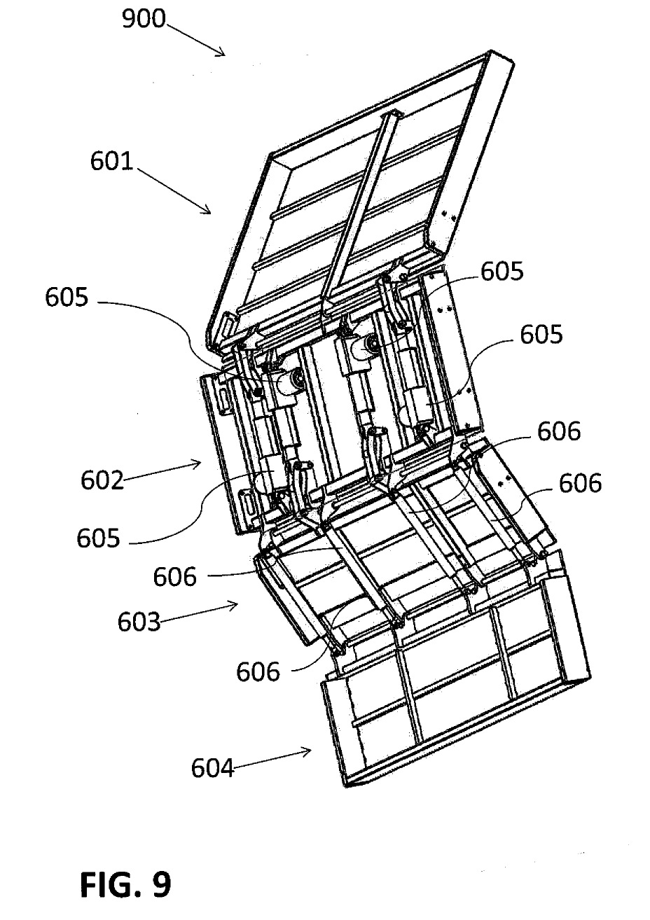

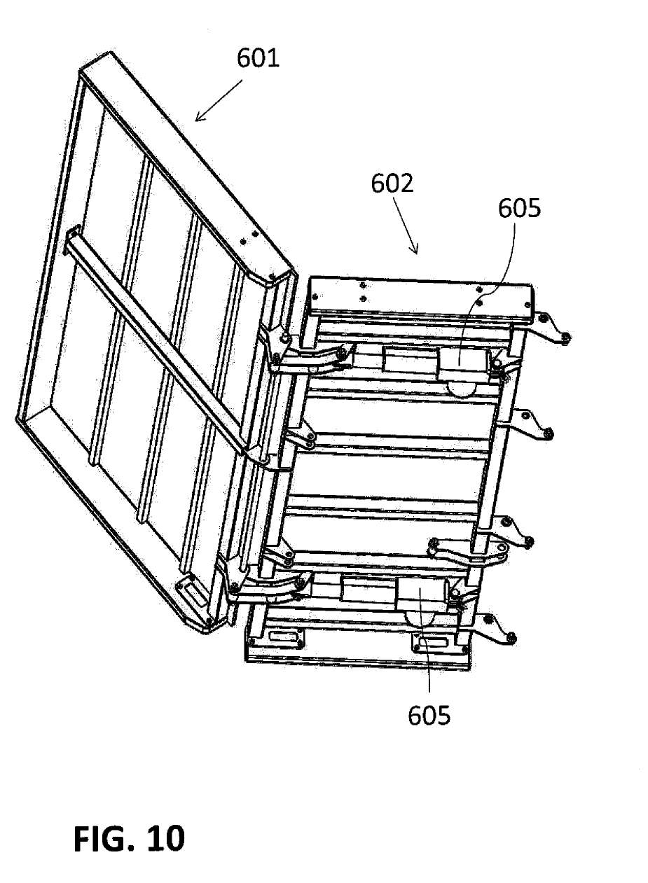

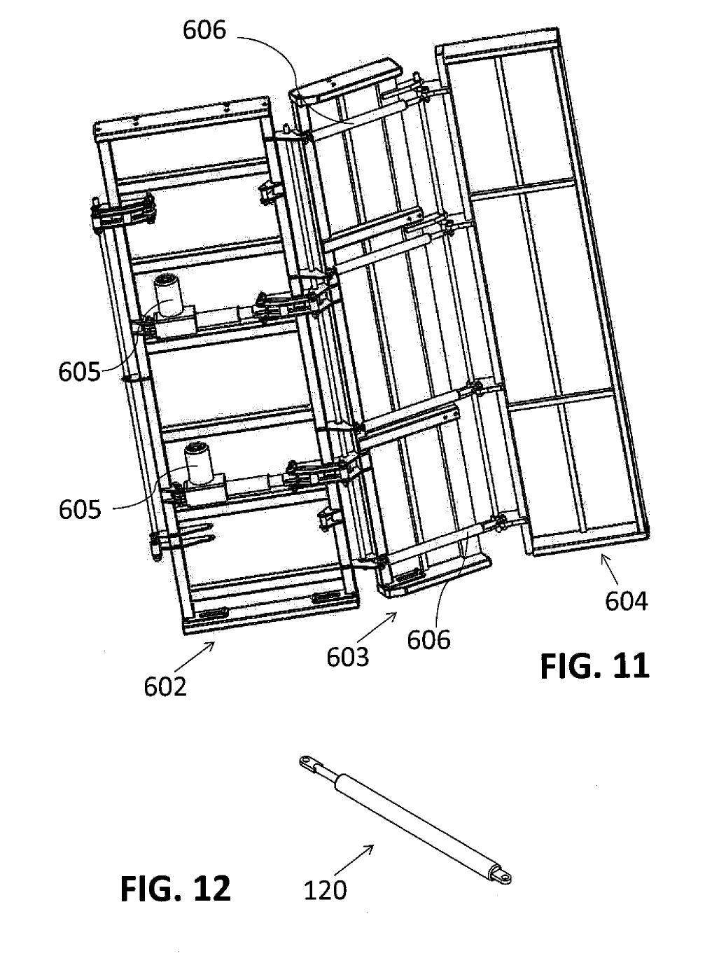

FIG. 5A schematically illustrates lower body segment 101c of FIG. 2 in a fully reclined position, along with lower body actuation module 301b, according to an embodiment of the present invention. Lower body segment 101c comprises a thigh section 501 and a calf section 502. In this particular embodiment the structure and operation of lower body actuation module 301b is identical to those of upper body actuation module 301a. According to other embodiments of the invention, other actuation modules may be provided to either or both of the body actuation modules 301a and 301b and the invention is not limited to a specific actuation module or to the use of identical actuation modules. FIG. 5B shows lower body segment 101c in a not-fully reclined position in which thigh section 501 is tilted in a different angle than calf section 502.

Thigh section 501 is connected, in this specific embodiment, to substructure 302 in the same manner that upper body segment 101a is connected thereto. The bottom side of calf section 502 is linked to substructure 302 by arms 503, while the top side of calf section 502 is axially connected to thigh section 501 by hinges 504 (one of which is seen in the figure) thereby separating between the thigh and calf sections during tilting, as demonstrated in FIG. 5B.

Motor 505 is configured to resist the torque force applied by lower body segment 101c being leaned upon, much like motor 401 and upper body segment 101a. Arms 503 are further used for transferring collapsing forces from calf section 502 to substructure 302 which serves as the base of the adjustable frame 101. Of course, the arms 503 shown in this exemplary embodiment can be substituted by any other element that serves the purpose of allowing the tilting movement of calf section 502, for instance, a separate motor.

According to an embodiment of the present invention, arms 503 comprise a force-absorbing apparatus, such as springs, pistons or other force absorbing apparatus, suitable to absorb forces applied to calf section 502. This embodiment is beneficial for preventing breaking of the connection between the calf section and thigh section or substructure 302 caused by heavy loads applied to calf section 502 and motor 505 being static and force-unabsorbent. In one exemplary embodiment of the invention arms 503 are gas springs such as gas spring 120 shown in FIG. 12.

In order to control electric motors 401 and 505, an electrical cable (104 in FIG. 1) is provided for connecting the mattress 100 to an electric outlet. In this embodiment an emergency power port may be provided for changing the position of the mattress in case of power outage. According to another embodiment of the present invention, mattress 100 comprises a rechargeable battery cell (e.g. lithium, not shown) configured to provide electric power to the motors 401 and 505, and a power charge port. In this embodiment the battery cell may be used in case of a power outage when electricity isn't available to change the position of the mattress, e.g. from tilted to reclined. According to another embodiment of the invention, a mechanical damping apparatus is provided for gently reclining mattress 100 in case electrical power isn't available (not shown).

According to an embodiment of the invention, an opening 105 (FIG. 1) in one or more sides of mattress 100 is provided for maintenance of electrical and/or mechanical components, such as replacing a degraded battery cell.

In contrast to common adjustable twin beds, where two mattresses may be separately adjusted by adjusting the bed's base beneath each mattress, according to an embodiment of the present invention, a large mattress (e.g. king- or queen-size) comprises two side-by-side frames 101 and two independent padding apparatuses 102, each on a frame 101, in order to adjust each side of the mattress separately. The flexible casing of the mattress comprises a fastening apparatus (e.g. a zipper) configured to bind the two independent padding apparatuses to a uniform large mattress and to allow separating of the mattress, for instance when separate adjusting is desired.

Frame 101 occupies a portion of the height of mattress 100, although it may be designed such that the height of the metal profiles, motors and other components of frame 101 allow padding apparatus to be high enough to provide the padding and comfort of a standard mattress while not exceeding the height of a standard mattress. According to an embodiment of the invention, the height of every component in frame 101 is 80 mm or less, leaving plenty of height for padding the mattress.

Referring back to FIG. 2, frame 101 comprises one or more sensors 106 configured to measure one or more parameters related to the sleep state of an individual on the bed. Sensor(s) 106 may be located at upper body segment 101a and/or at any other location throughout bed frame 101 from which parameters may be measured. Sensor(s) 106 may be of any type suitable to measure and gain data. Sensor types may include, but are not limited to: mechanical, electric, piezoelectric, optical, magnetic, electro-optical, electromagnetic, Infrared (IR), acoustic, ultrasonic, thermal, radioactive, or a combination of two or more of the forgoing.

Some parameters that can be measured by sensor(s) 106 and that indicate sleeping state include, but are not limited to:
the weight exerted on mattress 100 at various locations, which can change between different sleep states of an individual; sounds produced around mattress 100, e.g. snoring, heavy breathing, etc.;
motion across mattress 100, e.g. stillness, heavy breathing; and/or
subtle motions across mattress 100, e.g. changes in pulse rate.

Moreover, additional sensors can be provided in the frame or within the padding material, to sense parameters not related to the user but rather to the surroundings, such as for instance, temperature. Environmental parameters, e.g., light, sounds, state of equipment such as a TV set, etc., may also be sensed by sensors outside the mattress, which are found in data connection with the mattress' controller, for instance, via Wi-Fi, Bluetooth, or physical connection, directly or via cloud connection.

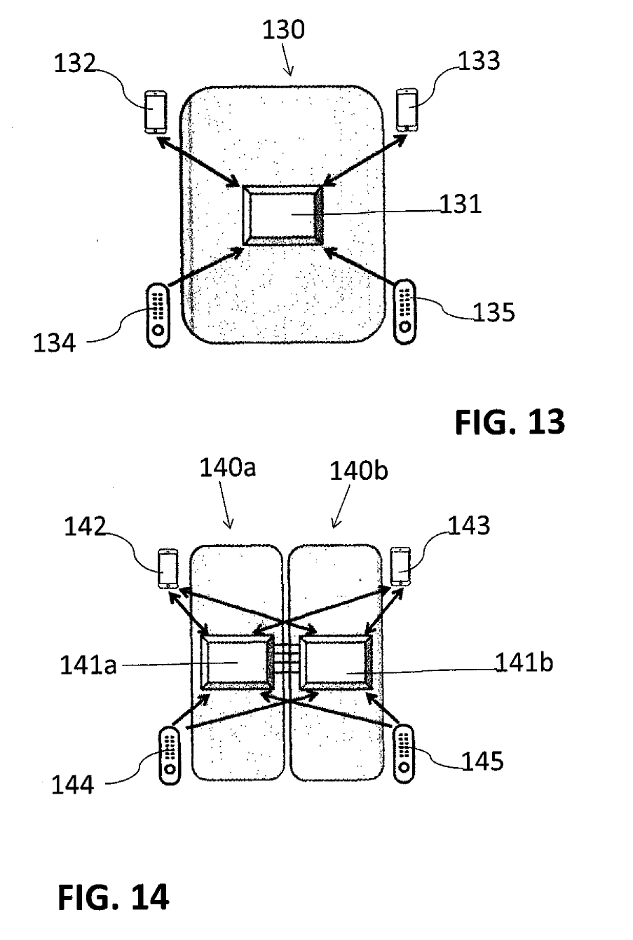

Bed frame 101 further comprises a control circuitry 107 (FIGS. 2, 58, also referred to herein as “mattress controller” or simply “controller”) to which measurements from sensor(s) 106 are sent, and which receives the current position of each of the bed frame segments. Control circuitry 107 comprises a processing unit configured to receive the measurements and accordingly to determine, for instance, whether or not an individual has fallen asleep on the mattress, upon which the upper and lower body actuation modules 301a and 301b are controlled and automatically brought by the control circuitry to a previously defined position (e.g. flat). In some embodiments control circuitry 107 may determine further states and automatically obtain a suitable predefined position of the mattress 100. For instance, upon determining that a television has been turned on the mattress may obtain a position suitable for watching television. Another example is the gentle lifting of section 101a to alleviate a snoring detected by a sensor 106. Of course, many other useful position changes can be provided in response to parameters detected, as will be easily appreciated by the skilled person.

Therefore, the adjustable comfort system of the invention may comprise an apparatus suitable to automatically bring the comfort system to a preferred sleeping position by the operation of an automatic position changing apparatus comprising sensing circuitry suitable to identify a user sleep state (e.g. whether or not a user has fallen asleep) and control circuitry suitable to control the position of the comfort system based on the identified sleep state.

According to an embodiment, control circuitry 107 is connected to various systems that control mattress 100's room environment, e.g. light switch, air conditioner, audio system, etc. In this embodiment, upon determining that an individual has fallen asleep the room environment systems are automatically brought to a predefined state by control circuitry 107 (for instance lights are turned off, temperature of the air conditioner is lowered and the audio system is muted). In this embodiment, therefore, controller 107 not only controls the operation of the adjustable mattress, but also the environment in which the mattress is located.

Programming of control circuitry 107 to user preferences can be performed so as to define the position to which mattress 100 is brought upon determining a sleeping state. Accordingly, a software application (not shown in the figures) is provided, with which a user may choose and define preferred positions. The software application can further be used for defining preferred states of room environment systems. Software applications can be provided in a dedicated appliance, or can be actuated from a mobile device, such as a mobile phone or a tablet. Moreover, control circuitry 107 can be adapted to change the aforementioned environmental parameters, or maybe in data connection, wired or wirelessly, with an external device that receives data relative to the sleeping state of the individual using the mattress and operates on the environmental parameters accordingly.

According to an embodiment, the processing unit of control circuitry 107 comprises a machine learning module capable of autonomously learning user habits and preferences and accordingly defining positions for different states. In this aspect, mattress 100 is an autonomous mattress suitable to autonomously accommodate its position to the activity and sleeping state of individuals.

Control circuitry 107 comprises a communications module suitable to communicate with the various abovementioned elements, i.e. sensor(s) 106, the upper and lower body actuation modules 301a and 301b, and, in some embodiments, environment control systems and mobile devices. Embodiments of the connection between the various elements and the communications module include wired connections, wireless connections and a combination of the two.

FIG. 6 (A-C) shows an arrangement of a frame 600 suitable for a queen-size mattress. In this specific embodiment the frame is divided into four sub-frames 601-604, in a manner similar to the division made for the single size mechanism shown in FIGS. 1-5. The actuating mechanism is hidden by the support plates onto which padding materials will rest once the mattress is assembled, which may be made of a variety of materials. In one embodiment the support plates are made of polycarbonate sheets, and in another embodiment of plywood. Openings 605 are provided in this specific embodiment for accommodating a small protrusion of the motors' transmission modules (402 in FIG. 4B).

FIG. 6B is a top view of frame 600, showing the dimensions (in millimeters) suitable for a queen-size mattress. FIG. 6C is a side view of frame 600, showing the hinges and rotation arrangements 606-608 that allow the tilting of the various section relative to one another.

FIG. 7 (A-B) shows the construction of frame 601. In FIG. 7A a polycarbonate sheet 701 is shown separated from the metal frame 601, which in this exemplary embodiment is made of two parts as shown in FIG. 7B, comprising aluminum partial frame 703 and iron partial frame 704. As will be appreciated by the skilled person, selecting the construction materials for each art of the mattress frame has an impact on the final weight thereof.

FIG. 8 is an exploded view of frame 602. In this particular embodiment the upper plate 801 is made of a polycarbonate sheet and the metal frame is made for the most part of iron 803, because it is the frame to which the motors are connected, with two side parts of the frame 802 made of aluminum, again for weight reduction purposes.

FIG. 9 is a bottom perspective view of a mechanism 900 adapted to operate a Queen-size mattress. Frame 602 houses four identical (in this embodiment) motors 605, and frame 603 houses four identical (in this embodiment) gas springs 606, which as said can be replaced by any other suitable element, such as a motor. The operation of the queen-size mattress mechanism is essentially as that of the single-size mechanism of FIGS. 1-5, and therefore reference is made to the description thereof, for the sake of brevity.

FIG. 10 is a perspective bottom view of the base and upper body lifting sections 601 and 602 of the mattress mechanism of FIG. 9, with only the two motors 605 needed to tilt section 601 being shown.

FIG. 11 is a perspective bottom view of the base (602) and legs sections (603, 604) of the mattress mechanism of FIG. 9, showing only the two motors 605 needed to operate this section.

Having described the mechanism and its operation, it is useful to list and appreciate some of the characteristics it imparts to the mattress containing it:
1. The adjustable mechanism is one of the inner layers of the mattress;
2. The mechanism is applicable to all sizes of existing mattresses (including single and double);
3. One mechanism can be connected to another, thus turning two single mechanisms into a double one;
4. The mechanism can be used with any type of mattress coils (such as continuous coils, Bonnell coils, offset coils, Marshall coils, etc.);
5. The mechanism can be used with mattresses of any height, materials, and comfort layers;
6. The mechanism is suitable for use in mattresses weighing up to 100 Kg., whether single or double;
7. The mechanism has 3 motion joints allowing motion in all three planes singularly or together;
8. The mechanism allows raising the head rest by an angle of 50°-60°;
9. The mechanism allows rising the calves plane to an angle of 40°-50°, and to tilt the legs plane to 5° below a plane parallel to the ground;
10. The mechanism operates quietly and sounds it generates do not exceed 55 db;
11. The inclusion of the mechanism does not diminish the comfort of the mattress;
12. The mechanism can be included such that it cannot be felt upon touch (applying pressure) at the sides of the mattress or on its surface;
13. The height of the mechanism does not exceed 80 mm at any position and it does not include external parts;
14. The weight of the mechanism for an 80/190 cm mattress is about 20 Kg;
15. The mechanism can lift up to 386 Kg evenly distributed on a Queen Size bed (156/203 cm);
16. The mechanism can be used without prior preparation on any supporting surface suitable to support a mattress, except for a flexible surface.

Although embodiments of the invention have been described by way of illustration, it will be understood that the invention may be carried out with many variations, modifications, and adaptations, without exceeding the scope of the claims.

1. An adjustable mattress frame suitable to be fully contained within a mattress, provided with a central body segment and with upper and lower body adjustable segments pivotally connected by one or more hinges to said central body segment, said central body segment being provided with two or more actuation modules suitable to actuate said upper and lower body segments respectively.

2. An adjustable mattress frame according to claim 1, wherein each actuation module comprises:
a. an electric motor;
b. a linear actuator; and
c. a motion-transmission module configured to transmit rotation of the motor to linear motion of the linear actuator.

3. An adjustable mattress frame according to claim 2, wherein the linear actuator is adapted to produce a linear motion that is transferred to the adjustable segment as a linear motion, by levers that are pivotally fixed on one side to the adjustable segment and on the other side to the base segment.

4. An adjustable mattress frame according to claim 1, wherein at least one adjustable segment comprises two sections, a first section abutting the base segment and a second section abutting the first section, and wherein both sections are adjusted simultaneously.

5. An adjustable mattress frame according to claim 4, wherein the second section of the adjustable segment comprises a top side pivotally connected by one or more hinges to the first section and a bottom side pivotally connected by arms to the base segment.

6. An adjustable mattress frame according to claim 4, further comprising a force absorbing apparatus suitable to absorb forces applied to the second section.

7. An adjustable mattress frame according to claim 1, having a thickness not greater than 8 cm.

8. An adjustable mattress comprising a frame according to claim 2, and further comprising a power source suitable to provide power to the motor, the power source being selected from:
A. an electrical cable configured to be connected to a power outlet;
B. a battery cell;
C. a rechargeable battery cell and a charge port;
D. a power port configured to receive power from a remote battery cell; or
E. a combination of two or more of the above.

9. An adjustable mattress comprising a frame according to claim 1, and further comprising padding material positioned on the frame, and boundary material that encases them, wherein no part of the frame extends outside said boundary material.

10. An adjustable mattress comprising a frame according to claim 1, which does not exceed the height and weight of a standard mattress.

11. An adjustable mattress comprising a frame according to claim 1, further comprising a maintenance opening.

12. An adjustable mattress according to claim 9, wherein the padding material comprises: springs; foam; memory foam; gel; or latex.

13. An adjustable twin, King size or queen-size mattress system comprising:
a) two adjustable frames according to claim 1 arranged parallel and adjacent to each other or integrally formed with one another to create a single double frame;
b) padding material located above each adjustable frame; and
c) flexible mattress-casing means enveloping said adjustable frames.

14. An adjustable mattress system according to claim 13, wherein the mattress casing means consists of two separate casings comprising a fastening apparatus configured to bind them into a uniform structure and to allow separation thereof.

15. An adjustable twin, King size or queen-size mattress system comprising:
a) one double-sized adjustable frame according to claim 1;
b) padding material located above said adjustable frame; and
c) flexible mattress-casing means enveloping said adjustable frame.

16. An adjustable mattress according to claim 1, wherein said actuation module is adapted to be operated automatically upon determination of a waking/sleeping state of a user.

17. An adjustable mattress according to claim 1, configured to be automatically brought to a previously defined position of the at least one adjustable segment.

18. An adjustable mattress according to claim 17, comprising:
i. one or more sensors configured to measure one or more parameters related to the sleep state of an individual; and
ii. a control circuitry to which measurements from the sensors are sent, configured to analyze the measurements and control the at least one adjustable segment for bringing it to the predefined position.

19. An adjustable mattress according to claim 18, wherein the one or more parameters are chosen from a list comprising: the weight exerted on the mattress at various locations, sounds produced around the mattress and motion across the mattress.

20. An adjustable mattress according to claim 17, further configured to automatically bring the environmental parameters of a room environment systems to a previously defined state.

21. An adjustable mattress according to claim 18, wherein the control circuitry comprises a machine learning module for autonomously learning habits and preferences, and accordingly defining mattress positions, and for autonomously obtaining the defined mattress positions.

22. An adjustable mattress system comprising an adjustable mattress according to claim 17, and a software application with which the previously defined position is defined.
